(19) United States
(12) Patent Application Publication
(10) Pub. No.: US 2020/0003641 A1
(43) Pub. Date: Jan. 2, 2020

(54) POWER METER FOR CYCLING

(71) Applicant: Scott Sports SA, Givisiez (CH)

(72) Inventors: Rico SÜSSE, Givisiez (CH); Pierre-Geoffroy PLANTET, Givisiez (CH)

(21) Appl. No.: 16/371,332

(22) Filed: Apr. 1, 2019

(30) Foreign Application Priority Data
Jul. 2, 2018 (DE) 20 2018 103 775.7

(51) Int. Cl. G01L 3/24; A63B 24/00

(52) U.S. Cl. CPC G01L 3/242; A63B 24/00; A63B 2220/16; A63B 2220/54; G01L 3/247

(57) ABSTRACT

A power meter for cycling is capable of measuring a positional and/or alignment change of a first measurement location on a rigid component of a human-powered vehicle relative to a second measurement location. Power output by the cyclist during cycling is then calculated based upon the measured positional and/or alignment change. The positional and/or alignment change may be measured using, e.g., a magnet/magnetic-field sensor pair or by a light source/light sensor pair.

### CROSS-REFERENCE TO RELATED APPLICATION

This application claims priority to German utility model application no. 20 2018 103 775.7 filed on Jul. 2, 2018, the contents of which are fully incorporated herein by reference.

### TECHNICAL FIELD

The present invention generally relates to power meters for cycling, e.g., for bicycles, that are capable of determining an amount of deformation of a rigid component for inferring a force applied to the rigid component during cycling, as well as to, e.g., a bicycle having such a power meter.

### BACKGROUND

In order to determine the power output of cyclist while cycling, it is known to provide a power meter on the bicycle. For example, some known power meters detect the deformation of a component of the drive train and determine (e.g., infer) therefrom the torque or force that is being applied (momentarily) to the component by the cyclist. The outputted power of the cyclist can be calculated therefrom in a known manner using (or by making an assumption with regard to) the rotational speed of the particular component.

It is known to use strain gauges to determine the deformation of such components. However, strain gauges have disadvantages. For example, it is difficult to connect such strain gauges to the component to be measured in a durable manner. Furthermore, strain gauges usually have small dimensions, such that only the deformation in a sub-region of a given component can be determined, whereas the force or torque applied to the component is usually not uniform over the entire component. In addition, strain gauges have a strong temperature dependence and thus results may vary depending on the ambient temperature.

Furthermore, it is also known to optically determine, for example, phase differences arising as a result of deformation. However, such an indirect measurement is usually inaccurate and usually requires structural modifications to the surrounding components (e.g., to the frame).

### SUMMARY OF THE DISCLOSURE

It is therefore one non-limiting object of the present teachings to provide one or more improved solutions for determining either the amount of pedal force applied by a rider or the pedal power output by the rider.

According to one non-limiting aspect of the present teachings, a power meter for cycling (e.g., for a bicycle) is capable of quantitatively determining a positional change of a first measurement location on a rigid component relative to a spatially-separate (spaced apart), second measurement location on the rigid component, which positional change results from a predetermined mechanical deformation of the rigid component. The rigid component is preferably formed in an integral manner (i.e. it is one piece). However, the rigid component can also be comprised of two or more components that are fixedly connected to one another.

The rigid component is part of the drive train that transmits a pedal force applied to the pedals to the rear wheel. Thus, the deformation occurs as a result of the application of a pedal force by a rider onto the pedals, for example, during cycling. The rigid component may be therefore, for example, a bottom bracket shaft that is optionally hollow (also known as a crankshaft or spindle), a sprocket (also known as a chainring-sprocket or chainring-spider) or a crank (also known as a pedal crank).

The resulting deformation or deforming of the rigid component may be, e.g., twisting, torsion, bending, elongating, stretching, compression, distortion, or shearing, or a combination of one or more of these types of deformation.

Preferably, the relative positional change of the two measurement locations is a spatial positional change and/or a relative orientation- or alignment-change. Furthermore, the deformation of the rigid body (rigid component) is reversible, elastic, and in the simplest case, proportional to the amount of force or torque momentarily acting on the rigid component.

According to another non-limiting aspect of the present teachings, the power meter preferably comprises a first free-standing cantilever, which is fixedly disposed (e.g., exclusively) at or on the first measurement location of the rigid component or is fixedly connected to the first measurement location (in the simplest case, it defines the first measurement location), such that the first cantilever has or defines a first translocated measurement point corresponding to the first measurement location. This (translocated) measurement point undergoes the same or identical positional change relative to the second measurement location as the first measurement location, at least when the predetermined deformation of the rigid component occurs. Thus, the first translocated measurement point is different from the first measurement location; that is, it is spatially spaced apart from the first measurement location. The first translocated measurement point is preferably formed by (at) an end, e.g., a terminal end, of the first cantilever.

This power meter further comprises a measuring sensor system for measuring the relative positional change between the first and the second measurement locations. Preferably, the measuring sensor system includes components that are (i) disposed at or on the first translocated measurement point and at or on the second measurement location or (ii) distributed over these two locations and the measuring sensor system performs a direct measurement between the first translocated measurement point and the second measurement location (or a second translocated measurement location, as will be explained below).

Such a power meter optionally further comprises a second free-standing cantilever, which is fixedly disposed (e.g., preferably exclusively) at or on the second measurement location of the rigid component or is fixedly connected to the second measurement location (in the simplest case, it defines the second measurement location), such that the second cantilever has or defines at least one second translocated measurement point that undergoes the same or the identical positional change relative to the first measurement location as the second measurement location. The second translocated measurement point is preferably formed by (at) an end (e.g., a terminal end) of the second cantilever. In embodiments in which the second cantilever is present, the measuring sensor system for measuring the relative positional change between the first and the second measurement locations includes components that are (i) disposed at or on the first translocated measurement point and at or on the second translocated measurement point or (ii) distributed over these two locations and the measuring sensor system performs a direct measurement between the first and second translocated measurement points.

In such embodiments, the first and the optional second cantilever is (are) configured or attached to the rigid component such that no deformation of the cantilever(s) itself/themselves occurs as a result of the predetermined deformation of the rigid component. For example, each cantilever can be formed in an integral manner with the rigid component or can be a component different from the rigid component, which itself is preferably formed in an integral manner.

According to the above-described aspect, at least one of the translocated measurement points is provided for a direct measurement using the measuring sensor system. At the translocated measurement point(s), the same positional change arises as at the underlying (corresponding) measurement location or at the measurement location pertinent to the deformation of the rigid component.

The spatial distance between the first translocated measurement point and either the second measurement location or the second translocated measurement point is preferably less than the spatial distance between the first and the second measurement locations. For example, the distance between the first translocated measurement point and either the second measurement location or the second translocated measurement point is less than 20 mm, 10 mm, 5 mm, 2 mm, 1 mm, 0.5 mm, 0.2 mm, or 0.1 mm, wherein each of the values mentioned can also be an upper or lower limit of a range of distances between the first translocated measurement point and either the second measurement location or the second translocated measurement point. This distance (spatial separation) may be defined, for example, by an air gap between a terminal end of the first cantilever and the second measurement location, or between the terminal ends of the first and second cantilevers, e.g. the closest points of the first and second cantilevers. In effect, the measurement locations, between which the relative positional change is to be determined, spatially converge (move closer together) when a force/torque is applied to the rigid component. Consequently, the present teachings (designs) enable the use of measuring methods and/or measuring sensor systems that would otherwise not be suitable if the measurement locations were spaced far (or farther) apart. Suitable examples of measuring sensor systems for use with the present teachings are provided in the following by way of example and without limitation.

It is advantageous if the spatial distance between the first and second measurement locations is as large as possible, since a maximum relative positional change between the first and second measurement locations thereby occurs with the predetermined deformation of the rigid component, thereby increasing the measurement accuracy and simplifying the measurement requirements. Accordingly, the spatial distance between the first and second measurement locations preferably falls between 5 cm and 30 cm and is, for example, 5 cm, 10 cm, 15 cm, 20 cm, 25 cm, or 30 cm, wherein each of the values mentioned can also be an upper or lower limit of the range mentioned. In such embodiments, the first and/or the second measurement location(s) preferably lies (lie) at an end of the rigid component. In the simplest case, the two measurement locations, i.e. the first and second measurement locations, respectively lie on (or proximal to) opposite ends (e.g., opposite lateral or axial ends) of the rigid component. That is, the ends are preferably selected such that a positional change or the maximum relative positional change occurs as a result of the predetermined deformation.

The free-standing (extension) length of a cantilever, i.e., in the simplest case the spatial displacement or the distance between a measurement location and the respective associated translocated measurement point, is preferably greater than or equal to 1 cm, 2 cm, 5 cm, 10 cm, 15 cm, or 20 cm, and is, for example, 1 cm, 2 cm, 3 cm, 5 cm, 10 cm, 15 cm, 20 cm, 25 cm or 30 cm, wherein each of the mentioned values can also be an upper or lower limit of a range of values defining the length of the cantilever, such as e.g., 2-10 cm. For example, the other end of the cantilever (i.e. the end that is opposite of the terminal end of a cantilever) is preferably proximately or directly disposed at or on the respective measurement location, so that the cantilever extends exactly (only) between the respective measurement location on the rigid component and the respective translocated measurement point.

In a preferred embodiment of the power meter, both of the first and second cantilevers are provided. Preferably the first and second cantilevers are disposed on the rigid component such that their respective terminal ends oppose each other and such that the distance between the two measurement points is small. It is also advantageous if the free-standing sections (extensions) of the two cantilevers have an identical length. The free-standing sections or the entire cantilevers are particularly preferably identically designed with regard to all dimensions and/or the materials used. When the two cantilevers are at least partially or completely identically designed (configured), they exhibit, for example, similar or identical deflections of their terminal ends as a result of external vibrations, so that in (to) a first approximation, no or at least a reduced or minimized relative positional change of the terminal ends and correspondingly of the translocated measurement points occurs as a result of external vibrations. Accordingly, the influence of external effects on the measurement signal captured by the measuring sensor system is reduced or minimized.

As was mentioned above, the rigid component is formed, for example, by (as) a bottom bracket shaft, a hollow bottom bracket shaft, a sprocket (spider), or a pedal crank. If the rigid component includes a cavity (hollow interior), such as, for example, a hollow bottom bracket shaft, the cantilever(s) is (are) preferably partially or completely disposed within the cavity. In such embodiments, no additional (external) space is required for the measurement system and the internal cantilever(s) is/are protected against external influences (e.g., water, mud, sun, etc.).

In a preferred embodiment a magnet/magnetic-field sensor pair is used as the measuring sensor system. For example, a magnet may be disposed at or on the first translocated measurement point (e.g., at the terminal end of the first cantilever), and a magnetic-field sensor is disposed at or on the second measurement location or at or on the second translocated measurement point (e.g., at the terminal end of the second cantilever). Alternatively the magnet can instead be disposed at or on the second measurement location or at or on the second measurement point and the magnetic-field sensor can be disposed at or on the first measurement point.

In such embodiments, the magnetic field at the location of the magnetic-field sensor is preferably oriented perpendicular or parallel or substantially perpendicular or parallel to a direct connecting line between magnet and magnetic-field sensor. In this case, a maximal magnetic field change is ensured at the magnetic-field sensor resulting from a relative positional change of the measurement locations or measurement points. It is furthermore preferred to use a magnet having sufficient strength such that, for example, no disturbances arise due to the Earth's magnetic field and in addition a strong measurement signal is available at the magnetic-field sensor. Accordingly, a magnet is preferably used that produces a magnetic field in the range of 10 mT to 1 T at the magnetic-field sensor, for example, 10 mT, 20 mT, 50 mT, 100 mT, 200 mT, 500 mT, or 1000 mT, wherein each of the mentioned values can also be an upper or lower limit of the range mentioned. The magnet is preferably a permanent magnet. However, it is also conceivable in principle to use an electromagnet or a remanently magnetized region as the magnetic field source.

In an alternative preferred embodiment, a rotary or linear potentiometer is used as the measuring sensor system. For example, the first translocated measurement point is fixedly connected to an operating (movable) element (e.g., a “wiper” or other movable contact) of the rotary or linear potentiometer, while the rotary or linear potentiometer itself (e.g., a housing thereof) is disposed at or on the second measurement location or measurement point, or vice versa. In such embodiments, the potentiometer is suitably selected and disposed in consideration of the amount and/or type of positional change resulting from the predetermined deformation. In other words, the direction of movement of the operating element of the potentiometer (rotational or translational displacement) preferably corresponds to the relative positional change of the measurement locations or measurement points resulting from the predetermined deformation.

In an alternative preferred embodiment, a light source, a light sensor, and a reflective surface (e.g., a patterned reflective surface) are used as the measuring sensor system. For example, the reflective surface may be disposed at or on the first translocated measurement point, and the light source and the light sensor may be disposed at or on the second measurement location or at or on the second translocated measurement point, or vice versa. In such embodiments, the reflective surface is irradiated by the light source, and the light sensor detects the light reflected by (from) the reflective surface in order to detect a relative positional change of the first and second measurement locations.

In another alternative preferred embodiment, a light source and a light sensor are used as the measuring sensor system (i.e. without the reflective surface). For example, the light source is disposed at or on the first translocated measurement point, and the light sensor is disposed at or on the second measurement location or at or on the second translocated measurement point, or vice versa. In such embodiments, the light sensor is configured to detect relative positional changes of the light source caused by deformation of the rigid component.

According to another aspect of the present teachings, a power meter for cycling (e.g., for a bicycle) is capable of quantitatively and directly determining a positional change of a first measurement location on a rigid component relative to a spatially-separate, second measurement location on the rigid component resulting from a predetermined mechanical deformation of the rigid component (e.g., a cantilever as described above is not included in this aspect of the present teachings). For example, in this aspect of the present teachings, the power meter preferably comprises a light source, e.g., a laser light source, disposed at or on the first measurement location that radiates light toward the second measurement location, and either a reflective surface (e.g., a patterned reflective surface) disposed at or on the second measurement location and a light source disposed at or on the first measurement location, or a light sensor disposed at or on the second measurement location.

In a preferred embodiment of this aspect of the present teachings, the rigid component includes an internal cavity (hollow interior) that is preferably completely closed. In such embodiments, the measurement locations or the light source and the light sensor and optionally the reflective surface are disposed in the cavity. For example, the rigid component is preferably a hollow bottom bracket shaft.

In other respects, the power meter according to this aspect can be designed, as applicable, similar the above-described power meter according to the preceding aspects.

The measuring sensor system preferably operates (senses) at a repetition rate (sampling rate) between 10 and 1000 Hz. For example, the measuring sensor system is controlled or sampled by a processing unit (e.g., a CPU) at a repetition rate (sampling rate) between 10 and 1000 Hz. This permits a sufficiently high (temporal) resolution at the expected pedaling- or rotational-frequencies or -speeds of the rigid component. The repetition rate (sampling rate) is, for example, 10 Hz, 20 Hz, 50 Hz, 100 Hz, 200 Hz, 500 Hz or 1000 Hz, wherein each of the mentioned values can also be an upper or lower limit of a range of sampling rate values.

The measuring sensor system preferably measures the positional change of the two measurement locations at (with) a resolution of at least 20, at least 50, at least 100, or at least 200 sampling values within the maximum or maximum-expected positional change. The deformation of the rigid component is thereby determined with a sufficiently high resolution in order to subsequently determine therefrom the force or the torque acting on the rigid component, or the pedal force applied via the pedals, or the pedal power output by a rider (cyclist). Typically, a torsion of 1° about the bottom bracket axis is effected, for example, in a bottom bracket shaft at the expected maximum load (for example, a force on a pedal corresponding to 100 kg). Even at the maximum load, the resulting deformations are rather small on other rigid components such as the sprocket or the crank. Accordingly, the deformation produced on the rigid component is proportional or at least substantially proportional to the force or torque acting on the pedal.

Power meters according to the present teachings preferably (optionally) comprise a measuring device, disposed on or in the rigid component, for measuring the rotational speed of the rigid component. In such embodiments, the rotational-speed-measuring device is preferably configured as a gyroscope and/or preferably measures at a repetition rate (sampling rate) between 10 and 1000 Hz. Particularly preferably, the rotational-speed-measuring device measures at the same repetition rate (sampling rate) as, and preferably simultaneously with, the measuring sensor system for determining the relative positional change. Data pairs are thereby generated by the measuring device and the measuring sensor system. Then, the (momentary) outputted power can be calculated directly from these data pairs.

Power meters according to the present teachings preferably (optionally) further comprise a radio transmitter that is preferably disposed on or in the rigid component. Preferably, the radio transmitter is capable of wireless transmission of measurement signals, preferably according to the “ANT+” or Bluetooth® radio standards (protocols). Furthermore the power meter may comprise a preferably rechargeable energy storage (e.g., a rechargeable battery) and/or a processing unit (e.g., a CPU), for example, for controlling the measuring sensor system, the rotational-speed-measuring device, and/or the radio transmitter, and/or for capturing, sampling, processing, and/or providing of measurement signals.

The present teachings further comprise a human-powered vehicle, e.g., a bicycle, such as a racing bicycle or a mountain bike, comprising any one of the power meters described above or below.

### BRIEF DESCRIPTION OF THE DRAWINGS

Further advantages of the teachings are described below with reference to the exemplary embodiments explained in the accompanying Figures. The exemplary embodiments represent preferred embodiments that do not restrict the invention in any way. The appended Figures are schematic representations that do not necessarily reflect the actual proportions but provide improved clarity and understanding of the particular exemplary embodiments.

FIGS. 1A, 1B and 1C show plan views of a bottom bracket shaft according to three different embodiments of the present teachings.

FIGS. 2A and 2B show a side view and a plan view of a pedal crank according to another embodiment of the present teachings.

FIG. 3A and 3B show a side view of a chainring with a spider according to two further embodiments of the present teachings.

### DETAILED DESCRIPTION OF EXEMPLARY EMBODIMENTS

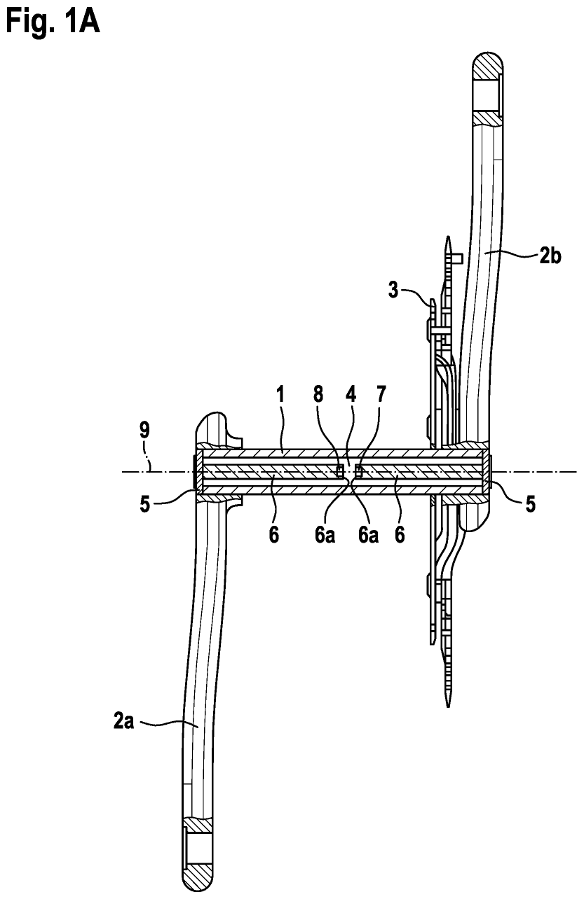

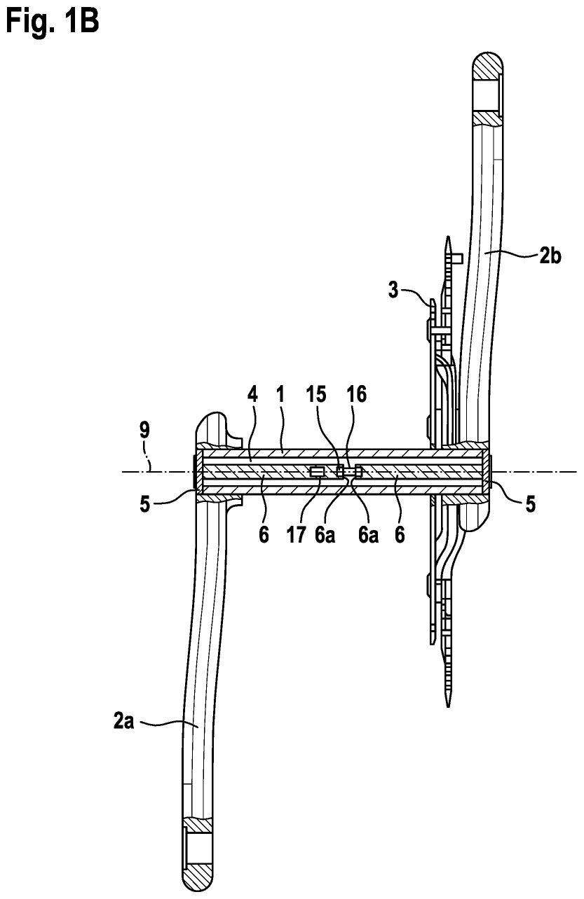

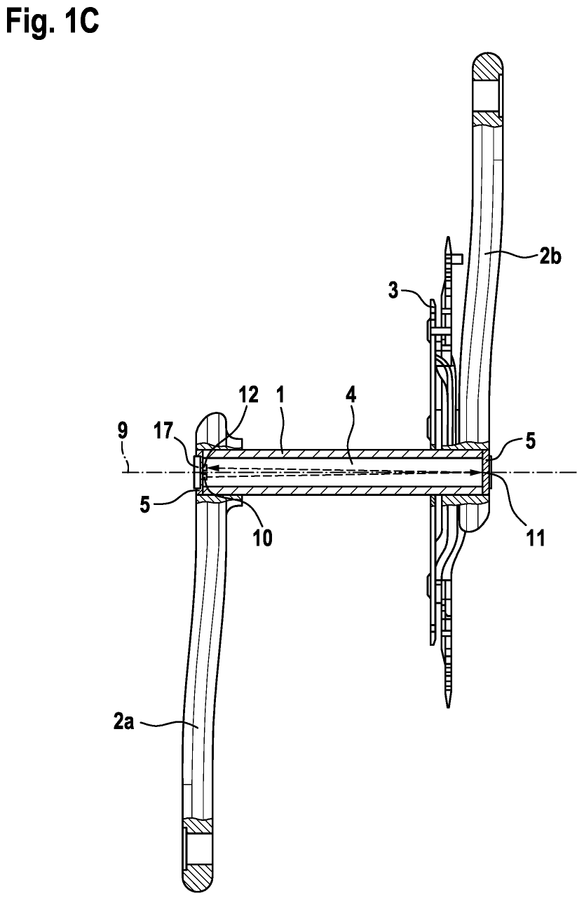

FIG. 1A shows a plan view of a hollow bottom bracket shaft 1 of a bicycle according to a first exemplary embodiment of the present teachings. The bottom bracket shaft 1 includes an attached left crank 2a, an attached right crank 2b and an attached chainring 3 on the side of the right crank 2b. The hollow bottom bracket shaft 1 has a cavity (hollow interior) 4 that is laterally closed, for example, by covers 5. In the first exemplary embodiment, free-standing cantilevers 6 are provided and respectively emanate from the covers 5 so as to protrude into the interior cavity 4. The cantilevers 6 are respectively connected to the ends (opposite lateral or axial ends) of the bottom bracket shaft 1 in a positionally fixed manner. Consequently, a twisting or torsion of the bottom bracket shaft 1 caused by a pedal force does not occur within the free-standing cantilevers 6 themselves.

The cantilevers 6 have opposing terminal ends 6a that are spaced apart by a small distance in the first exemplary embodiment, while the opposite lateral or axial ends of the bottom bracket shaft are spaced apart by a distance of 120 mm. In the first exemplary embodiment, a magnet 7 and a magnetic field sensor 8 are respectively integrated in the terminal ends 6a of the two cantilevers 6. Alternatively, a magnet 7 and/or magnetic field sensor 8 can instead be disposed on or against the opposing terminal ends 6a of the cantilever 6. At the location of the magnetic field sensor 8, the magnetic field generated by the magnet 7 points perpendicular to the bottom bracket axis 9.

Generally speaking, the distance between the terminal ends 6a or between magnet 7 and magnetic field sensor 8 is as small as possible in order to ensure a maximum magnetic field strength or magnetic penetration at the location of magnetic field sensor 8.

By applying a pedal force onto the pedal of the left crank 2a, a torsion (twisting) of the bottom bracket shaft 1 occurs. Since the cantilevers 6 are respectively connected in a positionally fixed manner to the opposite ends of the bottom bracket shaft 1 (in the present exemplary embodiment via the covers 5), the entire free-standing cantilevers 6 are each twisted as a whole, and in particular their respective terminal ends 6a are twisted relative to each other, in exactly the same manner as the opposite lateral ends of the bottom bracket shaft 1. In other words, the deformation or torsion of the bottom bracket shaft 1 that occurs at the opposite lateral ends of the bottom bracket shaft 1 can be measured at the terminal ends 6a of the cantilevers 6.

Thus the relative positional change of the opposite lateral ends of the bottom bracket shaft 1 (measurement locations), which are spaced relatively far apart from each other, can be detected at the terminal ends 6a (measurement points) of the free-standing cantilever arms 6, which terminal ends 6a lie close to each other. This reduced distance makes possible, for example, the use of a magnet/magnetic-field sensor pair as described above for measuring the relative positional change of the opposite lateral ends of the bottom bracket shaft 1.

It is noted that the above-described twisting (torsion) of the bottom bracket shaft 1 only occurs when a pedal force is applied via the left crank 2a since the chainring 3 is disposed in the vicinity of the right crank. Therefore, when a pedal force is applied onto the pedal of the right crank 2b, only a slight twisting of the bottom bracket shaft 1 takes place in the region between right crank 2b and chainring 3.

Instead of the magnet/magnetic-field sensor pair, a not-illustrated exemplary embodiment of the present teachings may include a light source, a light sensor, and optionally a reflective surface installed at or on the terminal ends 6a of the free-standing cantilevers 6. For example, a light source disposed at (or on) a first terminal end 6a illuminates a reflective surface disposed on the opposing second terminal end 6a. Then, the reflected light from the reflective surface is measured by a light sensor disposed on (or at) the first terminal end 6a in order to detect the positional change of the terminal ends 6a relative to each other. The reflective surface may optionally have a pattern that reflects patterned light, which is easier for the light sensor to spatially distinguish movement thereof.

In the exemplary embodiment shown in FIG. 1B, a body or housing of a rotary or rotational potentiometer 15 is provided on (attached to) a first terminal end 6a, such that the rotational axis of a rotary operating (rotatable) knob (contact) 16 thereof coincides with the bottom bracket axis 9. The rotary operating knob 16 of the rotary potentiometer 15 is connected to the opposing second terminal end 6a so that the rotary potentiometer 15 is actuated in response to a twisting of the bottom bracket shaft 1. A processing unit (control unit) 17 for processing signals from the rotary potentiometer 15 is also schematically shown in FIG. 1B.

In a further not-illustrated exemplary embodiment, only a single cantilever 6 is provided in the interior cavity 4 of the bottom bracket shaft 1. The single cantilever 6 is fixedly disposed at (attached to) a first lateral end of the bottom bracket shaft 1 and extends in a free-standing manner at least substantially over the entire cavity 4 up to the vicinity of the opposing second lateral end of the bottom bracket shaft 1. In this exemplary embodiment, any of the above-described measuring sensor systems can be disposed on the terminal end 6a of the single free-standing cantilever 6 and/or on the opposing lateral end of the bottom bracket shaft 1.

In the exemplary embodiment shown in FIG. 1C, a hollow bottom bracket shaft 1 having an interior cavity 4 is again shown. However, in this embodiment, no free-standing cantilevers 6 are provided, in contrast to the previous exemplary embodiments. Rather, the interior cavity 4 is used to optically and directly measure the positional change of the two opposite ends of the bottom bracket shaft 1. For this purpose a light source 10 in the form of a laser light source 10 is disposed at one lateral end of the bottom bracket shaft 1, or on a cover 5 as depicted in the exemplary embodiment, and this light source 10 emits light toward the opposite lateral end of the bottom bracket shaft 1. A reflective surface 11 is disposed on the cover 5 of the opposite lateral end of the bottom bracket shaft 1, or this opposite lateral end inherently has a reflective surface. For example, the reflective surface 11 is patterned and reflects in a mirror-like manner. The reflected light is detected by the light sensor 12, and a processing unit 17, e.g., mounted in or on the cover 5, determines the relative positional change of the two opposite lateral ends of the bottom bracket shaft 1 from changes in the reflected light detected by the light sensor 12. Of course, the processing unit 17 may be mounted elsewhere in or on the bottom bracket shaft 1 or separately, e.g., in a unit that is to be mounted on the handlebars. In this case, the light sensor 12 may wirelessly transmit signals representing the changes in the reflected light to a receiver also contained in the unit mounted on the handlebars and in electrical communication with the processing unit 17.

In a not-illustrated variant of this exemplary embodiment, the reflective surface 11 is omitted and the light source 10 and the light sensor 12 are respectively disposed on or at the opposite lateral ends of the bottom bracket shaft 1.

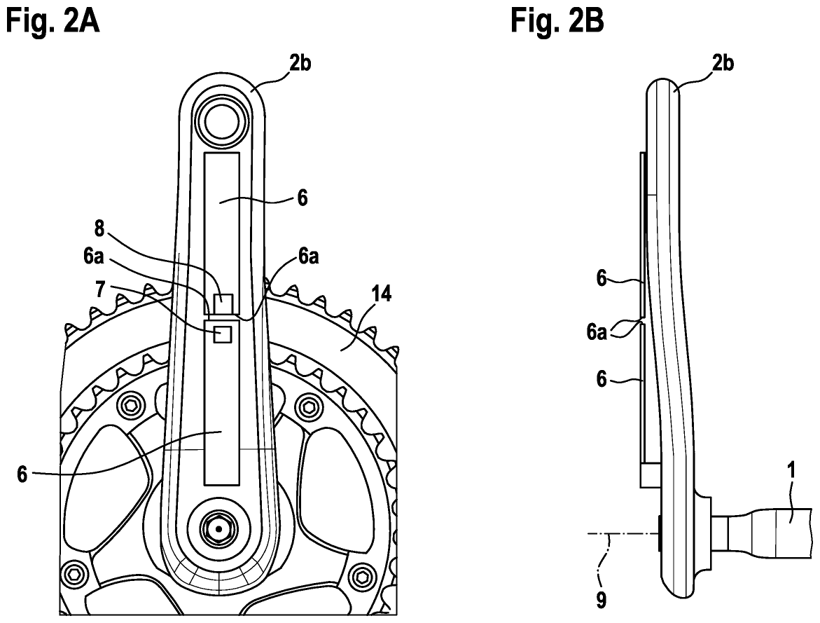

In the exemplary embodiment shown in FIGS. 2A and 2B, instead of the above-described hollow bottom bracket shaft 1, a crank (here the right crank 2b) is used as the rigid component, whose deformation is measured. In this exemplary embodiment, cantilevers 6 (e.g., outwardly disposed cantilevers 6) are respectively disposed so as to emanate from opposite lateral ends of the crank 2b or from the vicinity of the ends of the crank 2b (see the plan view of FIG. 2B). The cantilevers 6 extend toward each other in a free-standing manner up to the respective terminal ends 6a. As in the above-described exemplary embodiment of FIG. 1A, a magnet 7 and a magnetic field sensor 8 are respectively disposed at (or on) the two terminal ends 6a. Thus, when the crank 2b deforms owing to the application of a pedal force, the opposing terminal ends 6a of the free-standing cantilevers 6 tilt relative to each other.

In this embodiment, at the location of the magnetic field sensor 8, the magnetic field generated by the magnet 7 points, for example, toward the magnetic field sensor 8, which detects a change in the magnetic field direction when the crank 2b deforms. Alternatively the magnetic field at the magnetic field sensor 8 can instead be oriented parallel to the bottom bracket axis 9 or in the azimuthal direction with respect to the bottom bracket axis 9.

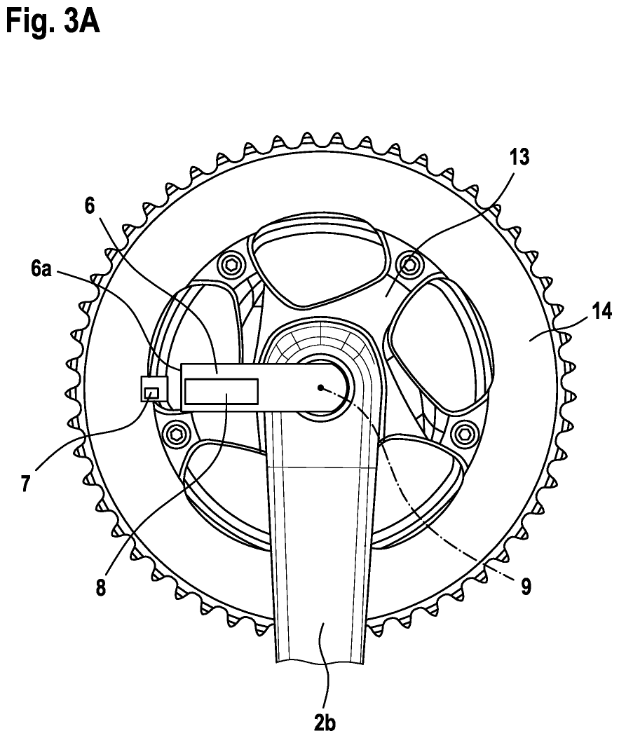

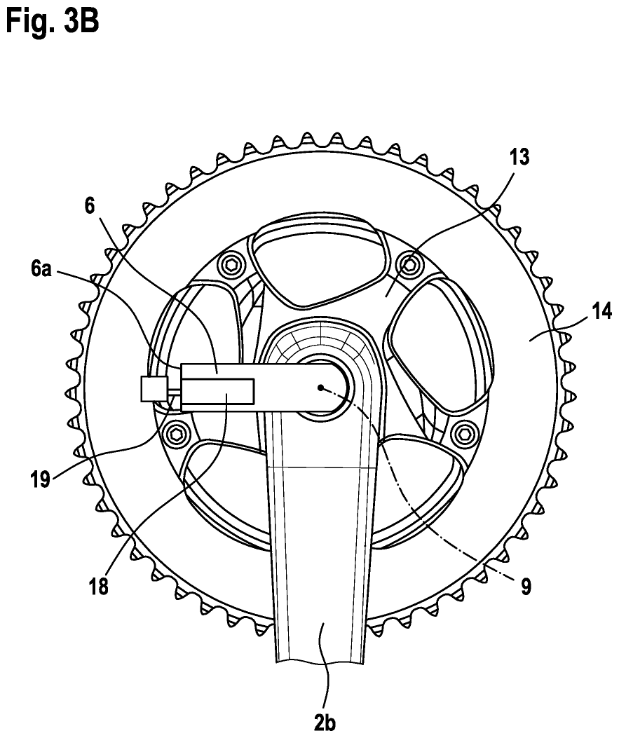

In the exemplary embodiment shown in FIG. 3A, the deformation is determined on a five-armed chainring-sprocket or a five-armed chainring-spider 13 as the rigid component of the drive train. For this purpose, a magnet 7 is disposed on an outer radius of the chainring-sprocket 13 or, as depicted in FIG. 3, outside the sprocket 13 directly on the chainring 14. At the height (level) of the bottom bracket 9, a cantilever 6 is attached that otherwise extends in a free-standing manner toward the magnet 7 so that the terminal end 6a of the cantilever 6 extends up to proximal to the magnet 7. A magnetic field sensor 8 is disposed at (or on) the terminal end 6a of the cantilever 6.

When the chainring-sprocket 13 deforms due to the application of a pedal force onto one of the pedals of the cranks 2a or 2b, the terminal end 6a of the cantilever 6 moves relative to the magnet 7 about the bottom bracket axis 9 (rotation about the bottom bracket axis 9). In this respect a substantially translatory movement relative to the magnet 7 arises at the terminal end 6a. Therefore, the magnet 7 is installed (mounted), for example, such that its magnetic field at the magnetic field sensor 8 is oriented parallel to the bottom bracket axis 9. Alternatively the magnetic field at the magnetic field sensor 8 can instead be oriented in the azimuthal direction with respect to the bottom bracket axis 9 or point from the magnet 7 toward the magnetic field sensor 8.

Instead of the magnet/magnetic-field sensor pair, the modified exemplary embodiment shown in FIG. 3B includes a linear potentiometer 18 that is disposed, for example, on the terminal end 6a of the cantilever 6. The operating (sliding) element 19 of the linear potentiometer is fixedly connected to the chainring 14 or to an outer radius of the chainring-sprocket 13.

Additional representative, non-limiting exemplary embodiments of the present teachings are described in the following.

A1. Meter device for a bicycle for determining the relative torsion of opposite axial (lateral) ends of a hollow bottom bracket shaft (1) during pedaling, comprising a first cantilever (6), which is fixedly connected to a first (axial or lateral) end of the bottom bracket shaft and extends in a free-standing manner along a bottom bracket axis (9) in a cavity of the hollow bottom bracket shaft toward a second opposite (axial or lateral) end of the bottom bracket shaft up to a terminal end (6a) of the first cantilever, wherein at least a part of a measuring sensor system (7, 8, 10, 11, 12) is disposed at (or on) the terminal end of the first cantilever.

A2.Meter device according to the above-embodiment A1, further comprising a second cantilever (6) that is fixedly connected to the second (axial or lateral) end of the bottom bracket shaft (1) and extends in a free-standing manner along the bottom bracket axis (9) in the cavity of the hollow bottom bracket shaft toward the opposite first (axial or lateral) end of the bottom bracket shaft up to a terminal end (6a) of the second cantilever so that the terminal ends of the first and second cantilevers oppose each other, wherein the remaining part of the measuring sensor system (7, 8, 10, 11, 12) is disposed at (or on) the terminal end of the second cantilever.

A3. Meter device according to the above-embodiment A1, wherein the remaining part of the measuring sensor system (7, 8, 10, 11, 12) is disposed at (on) the second (axial or lateral) end of the bottom bracket shaft (1).

A4. Meter device according to any one of the above-embodiments A1 to A3, wherein a magnet (7) is disposed at (or on) the terminal end (6a) of the first cantilever (6) and a magnetic field sensor (8) is disposed at (or on) the terminal end (6a) of the second cantilever (6) or at (or on) the second (axial or lateral) end of the bottom bracket shaft, or vice versa.

A5. Meter device according to the above-embodiment A4, wherein the magnetic field of the magnet (7) at the location of the magnetic field sensor (8) is oriented perpendicular or substantially perpendicular to the bottom bracket axis (9).

A6. Meter device according to any one of the above-embodiments A4 or A5, wherein the distance between the magnet (7) and the magnetic field sensor (8) is less than 20 mm, 10 mm, 5 mm, 2 mm, 1 mm, 0.5 mm.

A7. Meter device according to any one of the above-embodiments A1 to A3, wherein a preferably patterned reflective surface (11) is disposed at (or on) the terminal end (6a) of the first cantilever (6) and a light source (10) and a light sensor (12) are disposed at (or on) the terminal end (6a) of the second cantilever (6) or at (or on) the second (axial or lateral) end of the bottom bracket shaft (1), or vice versa.

A8. Meter device according to the above-embodiment A7, wherein the distance between the reflective surface (11) and the light source (10) or the light sensor (12) is less than 20 mm, 10 mm, 5 mm, 2 mm, 1 mm, 0.5 mm, 0.2 mm or 0.1 mm.

A9. Meter device according to any one of the above-embodiments A1 to A3, wherein a light source (10) is disposed at (or on) the terminal end (6a) of the first cantilever (6) and a light sensor (12) is disposed at (or on) the terminal end (6a) of the second cantilever (6) or at (or on) the second (axial or lateral) end of the bottom bracket shaft (1), or vice versa.

A10. Meter device according to any one of the above-embodiments A1 to A3, wherein a rotary potentiometer is disposed at (or on) the terminal end (6a) of the second cantilever (6) or at (or on) the second (axial or lateral) end of the bottom bracket shaft (1), and the terminal end (6a) of the first cantilever (6) is fixedly connected to a movable-rotary knob of the rotary potentiometer, wherein the (rotational) axis of the movable-rotary knob of the rotary potentiometer and the bottom bracket axis (9) preferably coincide.

B1. Meter device for a bicycle for determining the relative twisting of opposite axial (lateral) ends of a hollow bottom bracket shaft (1) during pedaling, comprising a light source (10), preferably laser light source, disposed at a first (axial or lateral) end, which light source radiates toward the second (axial or lateral) end, as well as either a preferably patterned reflective surface (11) disposed on (or at) the second end and a light sensor (12) disposed on (or at) the first (axial or lateral) end or a light sensor (12) disposed on (or at) the second (axial or lateral) end.

C1. Meter device for a bicycle for determining the relative deformation of a chainring-sprocket (13) during pedaling, comprising a first cantilever (6) that is centrally attached to the chainring (14) or the chainring-sprocket (13) or to the bottom bracket shaft (1) and extends in a free-standing manner on the chainring-inner-side or -outer-side up to a terminal end (6a) of the first cantilever (6), wherein at least a part of a measuring sensor system (7, 8) is disposed at (or on) the terminal end (6a) of the first cantilever (6).

C2. Meter device according to the above-embodiment C1, further comprising a second cantilever (6) that is attached radially outwardly to the chainring-sprocket (13) or to a chainring (14) and extends radially inward in a free-standing manner up to a terminal end (6a) of the second cantilever (6) so that the terminal ends (6a) of first and second cantilevers (6) face each other, wherein the remaining part of the measuring sensor system (7, 8) is disposed at (or on) the terminal end (6a) of the second cantilever (6).

C3. Meter device according to the above-embodiment C1, wherein the remaining part of the measuring sensor system (7, 8) is attached radially outwardly to the chainring-sprocket (13) or a chainring (14).

C4. Meter device according to any one of the above-embodiments C1 to C3, wherein a magnet (7) is disposed at (or on) the terminal end (6a) of the first cantilever (6) and a magnetic field sensor (8) is disposed at (or on) the terminal end (6a) of the second cantilever (6) or radially outward on the chainring-sprocket (13) or on the chainring (14), or vice versa.

C5. Meter device according to the above-embodiment C4, wherein the magnetic field at the location of the magnetic field sensor (8) is oriented parallel or substantially parallel to a bottom bracket axis (9) or in the azimuthal direction with respect to the bottom bracket axis (9) or points toward the magnetic field sensor (8).

C6. Meter device according to the above-embodiments C4 or C5, wherein the distance between magnet (7) and magnetic field sensor (8) is less than 20 mm, 10 mm, 5 mm, 2 mm, 1 mm, 0.5 mm.

C7. Meter device according to any one of the above-embodiments C1 to C3, wherein a linear potentiometer is disposed at (or on) the terminal end (6a) of the second cantilever (6) or radially outwardly on the chainring-sprocket (13) or on the chainring (14) and the terminal end (6a) of the first cantilever (6) is fixedly connected to (or on) a movable-slider of the linear potentiometer.

D1. Meter device for a bicycle for determining the relative bending of a pedal crank (2a, 2b) during pedaling, comprising a first cantilever (6) that is fixedly connected to the pedal crank at a first end of the pedal crank or in the vicinity of the first end of the pedal crank and extends in a free-standing manner along the crank-inner-side or crank-outer-side toward an opposite second end of the pedal crank up to a terminal end (6a) of the first cantilever (6), wherein at least a part of a measuring sensor system (7, 8) is disposed at (or on) the terminal end of the first cantilever.

D2. Meter device according to the above-embodiment D1, further comprising a second cantilever (6) that is fixedly connected to the pedal crank at (or on) a second end of the pedal crank (2a, 2b) or in the vicinity of the second end of the pedal crank and extends in a free-standing manner toward the opposite first end of the pedal crank up to a terminal end (6a) of the second cantilever (6), wherein at least a part of a measuring sensor system (7, 8) is disposed at (or on) the terminal end of the second cantilever.

D3. Meter device according to embodiment D1, wherein the remaining part of the measuring sensor system (7, 8) is disposed at (or on) the second end of the pedal crank (2a, 2b).

D4. Meter device according to any one of the above-embodiments D1 to D3, wherein a magnet (7) is disposed at (or on) the terminal end (6a) of the first cantilever (6) and a magnetic field sensor (8) is disposed at (or on) the terminal end (6a) of the second cantilever (6) or at (or on) the second end of the bottom bracket shaft, or vice versa.

D5. Meter device according to the above-embodiment D4, wherein the magnetic field at the location of the magnetic field sensor (8) is oriented parallel or substantially parallel to a bottom bracket axis (9) or in the azimuthal direction with respect to the bottom bracket axis (9) or points toward the magnetic field sensor (8).

D6. Meter device according to any one of the above-embodiments D4 or D5, wherein the distance between magnet (7) and magnetic field sensor (8) is less than 20 mm, 10 mm, 5 mm, 2 mm, 1 mm, 0.5 mm, 0.2 mm or 0.1 mm.

E1. Meter device for a bicycle for determining a positional change of a first measurement location relative to a second measurement location on a rigid component (1, 2a, 2b, 13) resulting from a predetermined deformation of the rigid component, comprising

a first free-standing cantilever (6) that is disposed at (or on) the first measurement location of the rigid component in a positionally fixed manner or is connected in a positionally fixed manner to (or on) the first measurement location such that the first cantilever defines at least one first translocated measurement point that has (undergoes) the same positional change relative to the second measurement location as the first measurement location,

optionally a second free-standing cantilever (6) that is disposed at (or on) the second measurement location of the rigid component in a positionally fixed manner or is connected to (or on) the second measurement location in a positionally fixed manner such that the second cantilever defines at least one second translocated measurement point that has (undergoes) the same positional change relative to the first measurement location as the second measurement location, and

a measuring sensor system (7, 8, 10; 11, 12) that is disposed at (or on) the first translocated measurement point and (either) at (or on) the second measurement location or at (or on) the second translocated measurement point.

E2. Meter device according to the above-embodiment E1, wherein the spatial distance between the first translocated measurement point and (either) the second measurement location or the second translocated measurement point is less than the spatial distance between the first and the second measurement locations, and the distance between the first translocated measurement point and (either) the second measurement location or the second translocated measurement point is preferably less than 20 mm, 10 mm, 5 mm, 2 mm, 1 mm, 0.5 mm, 0.2 mm, or 0.1 mm.

E3. Meter device according to the above-embodiment E1 or E2, wherein the spatial distance between the first and second measurement locations falls between 5 cm and 30 cm and is, for example, 5 cm, 10 cm, 15 cm, 20 cm, 25 cm, or 30 cm.

E4. Meter device according to any one of the preceding embodiments E1-E3, wherein the first and second measurement locations are respectively located at opposite (lateral or axial) ends of the rigid component (1, 2a, 2b, 13).

E5. Meter device according to any one of the preceding embodiments E1-E4, wherein the predetermined deformation occurs as a result of an application of a pedal force.

E6. Meter device according to any one of the preceding embodiments E1-E5, wherein (one or both of) the translocated measurement points or the translocated measurement points is/are formed by an end, preferably a terminal end (6a), of the respective cantilever (6).

E7. Meter device according to any one of the preceding embodiments E1-E6, wherein an end of the cantilever that is opposite of a terminal end (6a) of the cantilever (6) is disposed directly at (or on) the respective measurement location.

E8. Meter device according to any one of the preceding embodiments E1-E7, wherein the cantilever(s) include(s) a free-standing section having a length of at least 1 cm, 2 cm, 5 cm, 10 cm, 15 cm or 20 cm.

E9. Meter device according to any one of the preceding embodiments E1-E8, wherein first and second cantilevers (6) are provided therein, wherein preferably their terminal ends (6a) face each other and/or wherein preferably the free-standing sections of the cantilevers have an identical length and particularly preferably the free-standing sections or the entire cantilevers have identical dimensions.

E10. Meter device according to any one of the preceding embodiments E1-E9, wherein the relative positional change of the measurement locations or of the translocated measurement points is formed by a spatial positional change and/or by a change of the relative orientation or alignment.

E11. Meter device according to any one of the preceding embodiments E1-E10, wherein the deformation of the rigid body (1, 2a, 2b, 13) is proportional to the force and/or to the torque acting on the rigid body (rigid component).

E12. Meter device according to any one of the preceding embodiments E1-E11, wherein the rigid component (1, 2a, 2b, 13) is a bottom bracket shaft (1), such as a hollow bottom bracket shaft, a sprocket (13), or a pedal crank (2a, 2b).

E13. Meter device according to any one of the preceding embodiments E1-E12, wherein the rigid component is a hollow bottom bracket shaft (1) and the cantilever(s) is/are disposed inside the cavity (4).

E14. Meter device according to any one of the preceding embodiments E1-E13, wherein a magnet (7) is disposed at (or on) the first translocated measurement point and a magnet sensor (8) is disposed (either) at (or on) the second measurement location or at (or on) the second translocated measurement point, or vice versa, wherein the magnetic field at the location of the magnet sensor is preferably oriented perpendicular or substantially perpendicular or parallel to a direct connecting line between magnet and magnet sensor and/or the magnet generates a magnetic field in the range of 10 mT to 1 T.

E15. Meter device according to any one of the preceding embodiments E1-E14, wherein an operating element for a rotary or linear potentiometer is fixedly connected to the first translocated measurement point and (the body or base of) the rotary or linear potentiometer is disposed (either) at (or on) the second measurement location or at (or on) the second measurement point, or vice versa.

E16. Meter device according to any one of the preceding embodiments E1-E15, wherein a light source (10) and a light sensor (12) are disposed at (or on) the first translocated measurement point, and a preferably patterned reflective surface (11) is disposed at (or on) the second measurement location or at (or on) the second measurement point, or vice versa.

E17. Meter device according to any one of the preceding embodiments E1-E16, wherein a light source (10) is disposed at (or on) the first translocated measurement point and a light sensor (12) is disposed (either) at (or on) the second measurement location or at (or on) the second measurement point, or vice versa.

E18. Meter device for a bicycle for determining a positional change of a first measurement location relative to a second measurement location on a rigid component (1), preferably a hollow bottom bracket shaft (1), resulting from a predetermined deformation of the rigid component, comprising a light source (10) disposed at (or on) the first measurement location, preferably a laser light source, that radiates toward the second measurement location, and either a preferably patterned reflective surface (11) disposed at (or on) the second measurement location and a light sensor (12) disposed at (or on) the first measurement location, or a light sensor (12) disposed at (or on) the second measurement location.

E19. Meter device according to the above-embodiment E18, wherein the rigid component (1) includes a (preferably closed) cavity (4), in which the light source (10), the light sensor (12) and optionally the reflective surface (11) are disposed, wherein the rigid component is preferably a hollow bottom bracket shaft.

E20. Meter device according to any one of embodiments E18 to E19, wherein the distance between the first and second measurement locations falls between 5 cm and 30 cm and is, for example, 5 cm, 10 cm, 15 cm, 20 cm, 25 cm, or 30 cm, and/or the first and second measurement locations respectively lie at (lateral or axial) ends of the rigid component.

E21. Meter device according to any one of embodiments E18 to E20, wherein the predetermined deformation occurs as a result of application of a pedal force.

E22. Meter device according to any one of embodiments E18 to E21, wherein the relative positional change of the measurement locations is formed (caused) by a spatial positional change and/or by a change of the relative orientation or alignment.

E23. Meter device according to any one of embodiments E18 to E22, wherein the deformation of the rigid body (rigid component) is proportional to the force and/or the torque acting on the rigid body.

E24. Meter device according to any one of the preceding embodiments E18-E23, wherein the measuring sensor system (7, 8, 10; 11, 12) measures at a repetition rate (sampling rate) of between 10 and 1000 Hz.

E25. Meter device according to any one of the preceding embodiments E18-E24, wherein the measuring sensor system (7, 8, 10; 11, 12) measures the positional change at a resolution of at least 20, at least 50, at least 100, or at least 200 sample values within the maximum positional change.

E26. Meter device according to any one of the preceding embodiments E18-E25, further comprising a measuring device for measuring the rotational speed of the rigid component, the measuring device preferably being configured as a gyroscope and/or preferably measures at a repetition rate (sampling rate) between 10 and 1000 Hz, preferably at the same repetition rate as the measuring sensor system.

E27. Meter device according to any one of the preceding embodiments E18-E26, further comprising a radio transmitter for wireless transmission of measurement signals, preferably according to the “ANT+” radio standard or Bluetooth® radio standard.

E28. Meter device according to any one of the preceding embodiments E18-E27, further comprising a (preferably rechargeable) energy storage (source, e.g., a battery) and/or a processing unit.

E29. Bicycle including a meter device according to any one of the preceding embodiments E1-E28.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved power meters for cycling.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the processing unit, is also understood as a corresponding method step or as a feature of a method step. In an analogous manner, aspects which have been described in the context of or as a method step also represent a description of a corresponding block or detail or feature of a corresponding device, such as the processing unit.

Depending on certain implementation requirements, exemplary embodiments of the processing unit of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the processing unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

I claim:

1. A power meter for cycling, comprising:
a first free-standing cantilever disposed at or on a first measurement location of a rigid component of a bicycle in a positionally fixed manner or connected in a positionally fixed manner to the first measurement location such that the first cantilever defines at least one first translocated measurement point that is configured to undergo the same positional change relative to a second measurement location of the rigid component as the first measurement location, the second measurement location being spaced apart from the first measurement location, and
a measuring sensor system disposed at or on the first translocated measurement point and either at or on the second measurement location or at or on a second translocated measurement point that is configured to undergo the same positional change relative to the second measurement location of the rigid component as the second measurement location, the measuring sensor system being configured to detect a positional change of the first measurement location relative to the second measurement location resulting from a predetermined deformation of the rigid component.

2. The power meter according to claim 1, further comprising a second free-standing cantilever that is disposed at or on the second measurement location of the rigid component in a positionally fixed manner or is connected to the second measurement location in a positionally fixed manner such that the second cantilever defines the second translocated measurement point that is configured to undergo the same positional change relative to the first measurement location as the second measurement location.

3. The power meter according to claim 1, wherein:
the first translocated measurement point is spaced from either the second measurement location or the second translocated measurement point by a first spatial distance that is less than a second spatial distance between the first and the second measurement locations, and
the first spatial distance is less than 5 mm.

4. The power meter according to claim 3, wherein the second spatial distance is between 5 cm and 30 cm.

5. The power meter according to claim 1, wherein the first and second measurement locations are respectively located at opposite ends of the rigid component.

6. The power meter according to claim 2, wherein the first and second translocated measurement points are respectively located at terminal ends the first and second cantilevers.

7. The power meter according to claim 1, wherein the first cantilever includes a free-standing section having a length of at least 1 cm.

8. The power meter according to claim 2, wherein:
terminal ends of the first and second cantilevers face each other and
free-standing sections of the first and second cantilevers have an identical length and dimension.

9. The power meter according to claim 1, wherein the rigid component of the bicycle is a bottom bracket shaft, a sprocket, or a pedal crank.

10. The power meter according to claim 1, wherein the rigid component is a hollow bottom bracket shaft and the first cantilever is disposed inside an internal cavity of the hollow bottom bracket shaft.

11. The power meter according to claim 1, further comprising:
a magnet disposed at or on one of (i) the first translocated measurement point or (ii) the second measurement location or the second translocated measurement point, and
a magnetic field sensor is disposed at or on the other of (i) the first translocated measurement point or (ii) the second measurement location or the second translocated measurement point,
wherein the magnetic field at the location of the magnetic field sensor is oriented perpendicular or substantially perpendicular or parallel to a line directly connecting the magnet and magnetic field sensor, and
the magnet generates a magnetic field in the range of 10 mT to 1 T.

12. The power meter according to claim 1, wherein:
a light source and a light sensor are disposed at one of (i) the first translocated measurement point or (ii) the second measurement location or the second translocated measurement point, and
a reflective surface is disposed at the other of (i) the first translocated measurement point or (ii) the second measurement location or the second measurement point.

13. The power meter according to claim 1, wherein:
a light source is disposed at one of (i) the first translocated measurement point or (ii) the second measurement location or the second translocated measurement point, and
a light sensor is disposed at the other of (i) the first translocated measurement point or (ii) the second measurement location or the second measurement point.

14. A power meter for cycling, comprising:
a light source disposed at or on a first measurement location of a rigid component that undergoes deformation during cycling, the light source being configured to radiate light toward a second measurement location of the rigid component,
either (i) a reflective surface disposed at or on the second measurement location and a light sensor disposed at or on the first measurement location, or (ii) a light sensor disposed at or on the second measurement location, and
a processing unit configured to determine a positional change of the first measurement location relative to the second measurement location based upon changes in a signal output by the light sensor as a result of deformation of the rigid component.

15. The power meter according to claim 14, wherein:
the rigid component is a hollow bottom bracket shaft having an internal cavity, and
at least the light source and the light sensor are disposed in the internal cavity.

16. The power meter according to claim 14, wherein the first and second measurement locations are located at opposite ends of the rigid component and are spaced 5-30 cm apart.

17. The power meter according to claim 14, wherein the positional change is a spatial positional change of the first measurement location relative to the second measurement location and/or a change of orientation or alignment of the first measurement location relative to the second measurement location.

18. The power meter according to claim 1, wherein the measuring sensor system is configured to take measurements at a sampling rate of between 10 and 1000 Hz.

19. The power meter according to claim 18, wherein the measuring sensor system is configured to take measurements at a resolution of at least 20 sample values within a maximum range of positional change.

20. The power meter according to claim 1, further comprising a measuring device configured to measure the rotational speed of the rigid component.
